(19) United States
(12) Patent Application Publication
(10) Pub. No.: US 2023/0411062 A1
(43) Pub. Date: Dec. 21, 2023

(54) CHOKE COIL

(71) Applicant: SHT Corporation Limited, Izumisano-shi, Osaka (JP)

(72) Inventors: Masafumi INOUE, Izumisano-shi, Osaka (JP); Yasuomi TAKAHASHI, Izumisano-shi, Osaka (JP); Tsunetsugu IMANISHI, Izumisano-shi, Osaka (JP)

(73) Assignee: SHT Corporation, Izumisano-shi, Osaka (JP)

(21) Appl. No.: 18/031,530

(22) PCT Filed: Sep. 7, 2021
(86) PCT No.: PCT/JP2021/032796

§ 371 Date: Apr. 12, 2023

(30) Foreign Application Priority Data
Oct. 19, 2020 (JP) 2020-175093

(51) Int. Cl. H01F 17/06; H01F 27/29; H01F 27/32

(52) U.S. Cl. CPC H01F 17/062; H01F 27/324; H01F 27/292

(57) ABSTRACT

The present invention provides a choke coil suitable for high-frequency circuits with high occupancy ratio and high manufacturing efficiency.

The present choke coil 10 comprises a pair of core pieces 20, 20, wherein each of the core pieces comprises an arc-shaped core segment 31 having end faces 32, 32a,a molded insulating coating 34 to cover the core segment and provide the core segment with an electrical insulation, the molded insulating coating having flanges 35, 35 extending outward from each of the end faces of the core segment, a coated wire 40 wound around the molded insulating coating, and terminals 50, 50 provided near the flange of the molded insulating coating and electrically connected to the coated wire, wherein the choke coil is a toroidal shape formed by placing the end faces of the arc-shaped core segment of one of the core pieces to face the end faces of the arc-shaped core segment of the other core piece, and the coated wire is wound around the circumference of the molded insulating coating in parallel without being twisted to each other and is electrically connected to the terminals.

### TECHNICAL FIELD

The present invention relates to choke coils used in high-frequency current suppression circuits, waveform shaping circuits, power factor correction circuits, and various switching power supply circuits installed in equipment that handles alternating current, such as switching power supply units and inverter devices. More specifically, the present invention relates to toroidal-shaped choke coils used in switching-type power supply circuits driven at frequencies “f” as high as about 10 kHz to 150 kHz, wherein the choke coils having windings wound in a high occupancy ratio are produced using automatic winding equipment with machines, thus achieving high manufacturing efficiency, high quality, and stable supply.

### BACKGROUND ART

Choke coils used in power supply circuits and high-frequency circuits of various AC devices are composed of a toroidal core covered with a molded insulating coating that is formed by a bobbin or a surface treatment, and have windings wound multiple turns with a coated wire (magnet wire).

When winding the coated wire around the toroidal core, the winding process must repeatedly draw the coated wire through a central hole for the designed number of turns, depending on the required characteristics. However, the winding procedure to achieve this requirement isn't easy to mechanize since the central hole is formed as small as possible to reduce the size of the toroidal core. So, turning the coated wire requires to be performed manually. When the wire diameter is relatively small, for example, 0.8 mm or less in diameter, the number of turns needs more than several hundred times. On the other hand, in the case of a wire diameter of 2.0 mm or larger, for example, the number of turns is small, but the hardness of the coated wire makes it difficult to operate and places a heavy burden on the worker. Consequently, it was difficult to continue mass production.

To solve the winding issue as mentioned above, there was conventionally proposed to prepare a pair of core pieces, each comprising an arc-shaped core segment covered with a molded insulating coating and wound around with coated wire, and then to combine the core pieces into a toroidal-shaped choke coil (For example, see Patent Documents 1 and 2). The coated wire is wound starting at one end edge of the core segment, wound around the body of the core segment, and then terminates at the other end edge.

### PRIOR ART DOCUMENT (S)

### Patent Document

Patent Document 1: Microfilm of Japanese Utility Model Application HEI 01-98725 (Japanese Utility Model Publication HEI 03-38603)

Patent Document 2: Japanese Patent Application Publication 2001-52945

### SUMMARY OF THE INVENTION

### Problems to be Solved by the Invention

In recent years, power semiconductor devices used in switching power supplies and inverter devices have been remarkably increased in speed, and choke coils used in these power supply circuits are also required to suppress high-frequency losses and reduce size so as to be suitable for high-frequency circuits. Choke coil losses include iron loss and copper loss, wherein the iron loss depends on the magnetic material employed as the core.

On the other hand, as for the copper loss, one of the loss factors is DC resistance loss of the winding. To reduce the DC resistance loss of the winding, the ratio of the copper portion of the coated wire to the core, i.e., the occupancy ratio, must be increased. For choke coils disclosed in Patent Documents 1 and 2, DC resistance loss may be reduced by increasing the occupancy ratio, using a coated wire with a larger diameter while securing the number of turns on the core segment. However, winding the larger-diameter coated wire around the arc-shaped core segment many turns is difficult not only by machine but also by hand, resulting in misalignment of the coated wire and collapse of the coated wire when wound. Thus, the use of such coated wire is not practical.

The second factor in the copper loss is epidermal effect phenomenon caused by high-frequency currents. As the frequency “f” increases, the internal resistance of the copper wire increases and the current becomes more surface-tendentious. For the copper wire, the skin depth is expressed as 66.1/f^{1/2} (mm), and the loss increases as the effective copper wire cross-sectional area decreases, leading to heat generation. Therefore, the copper wire diameter in the choke coil must also be selected to suit the frequency “f,” and the number of wires having a cross-sectional area corresponding to the current capacity needs to be prepared.

It is therefore contemplated to prepare a number of Litz wire (indicated as 91 in FIGS. 13-15) made of twisted and bundled multiple copper wire 92 and having a cross-sectional area corresponding to the required current capacity, and to wind the Litz wire 91 around the core segment 31. However, as shown in the example below, the occupancy ratio of Litz wire 91 decreases because of the large gap “s” between the copper wire 92, the bulkiness of the coating, and the gap “S” between the thickly twisted wires. As a result, the number of turns in the central hole of the toroidal core becomes much smaller, leading to a larger size of the core. In addition, the Litz wire 91 tends to unwind during and after winding due to its residual stress (restoring force), causing the finished product to bulge and enlarge. Litz wire further requires a unique design and preparation for the diameter and number of strands, depending on the frequency. So, a lot of work and higher costs are inevitable.

The object of the present invention is to provide a choke coil with a high occupancy ratio and a high manufacturing efficiency, and suitable for high-frequency circuits.

### Means to Solve the Problems

The present invention provides a choke coil comprising a pair of core pieces, wherein each of the core pieces comprises an arc-shaped core segment having end faces, a molded insulating coating to cover the core segment and provide the core segment with an electrical insulation, the molded insulating coating having flanges extending outward from each of the end faces of the core segment, a coated wire wound around the molded insulating coating, and terminals disposed near the flanges of the molded insulating coating and electrically connected to the coated wire, wherein the choke coil is a toroidal shape formed by placing the end faces of the core segment of one of the core pieces to face the end faces of the core segment of the other core piece, the coated wire is wound around the circumference of the molded insulating coating, in parallel without being twisted to each other and is electrically connected to the terminals.

The coated wire is wound in layers along a peripheral surface of the molded insulating coating, wherein a first layer of one coated wire is present on the inner most circumferential side of the molded insulating coating, and a second layer of one coated layer is stacked on the outer circumference of the first layer in sequence.

The coated wire is wound while changing the direction of winding at the terminals.

The coated wire comprises a plural coated wires that are wound without changing the direction of winding.

The coated wire is preferably wound around the molded insulating coating such that the central region of the wound-coated wire bulges on the inner circumferential side of the insulating coating.

The terminals are electrically connected to the coated wire via resistance welding, welding method, or soldering.

A choke coil product according to the present invention is produced by coating outer circumference of the above-mentioned choke coil with resin.

### Effects of the Invention

The choke coil of the present invention provides higher density winding and ensures a higher occupancy ratio than Litz wire because each core piece has a plurality of coated wires wound in parallel, thus achieving smaller size and higher performance of choke coils. The coated wire can be wound on a molded insulating coating of an arc-shaped core segment, so it can be manufactured by making full use of automatic winding equipment using machines, to thereby achieve an increased manufacturing efficiency. Specifically, for the structure of multiple coated wire wound in layers, a first layer of one coated wire is provided on the inner circumferential side of the core piece, and a second layer of one coated wire is stacked on the outer circumference of the core piece in sequence so that the coated wire can be wound stably without misalignment, collapse, or variation of the coated wire.

The pair of core pieces can be formed into a toroidal-shaped choke coil by placing the end faces of one of the core pieces to face those of the other core piece, thus making it possible to enhance the manufacturing efficiency of the choke coil to the greatest extent possible.

As described above, the present invention requires only multiple copper wires consisting of a solid wire to be wound in parallel for the coated wire, and does not require the use of expensive Litz wire that require a dedicated design, thus achieving the cost reductions, as compared to Litz wire. In addition, the copper wire without being twisted provides a high occupancy ratio and enables to set arbitrary number of wires.

The choke coil of the present invention is suitable as a choke coil used in high-frequency current suppression circuits, waveform shaping circuits, power factor correction circuits, and various switching power supply circuits in devices that handle alternating current, such as switching power supply devices and inverter devices. Winding the coated wire can be performed stably without any misalignment, collapse, or variation of the coated wire, thus reducing variations in the frequency and inductance characteristics of the high-frequency choke coils caused by these factors. The toroidal-shaped choke coil of the present invention is an ideal magnetic circuit and is particularly useful for switching power supply circuits that are driven at high frequencies “f” of about 10 kHz to 150 kHz. The choke coil having windings with a high occupancy ratio can be produced by automatic winding equipment using machines, whereby high production efficiency, high quality, and stable supply can be realized.

### BRIEF DESCRIPTION OF THE DRAWINGS

FIG. 1 is a perspective view of the choke coil of the present invention.

FIG. 2 is a perspective view of the core segment covered with a resin coating over all except the end faces.

FIG. 3 is a perspective view of the core piece wound around with the coated wire (before attaching the terminals).

FIG. 4 is a plan view of the core piece shown in FIG. 3.

FIG. 5 is a cross-sectional view of the core piece, showing the steps (a) to (c) of winding the coated wire in layers.

FIG. 6 shows an example of the core piece, wherein (a) is a cross-sectional view of the core piece wound with the coated wire (only the central space side is shown) and (b) is an enlarged view of the enclosure A indicated in (a).

FIG. 7 is a cross-sectional view showing the state of the core piece wound with the coated wire until the central space on the inner circumference side of the core piece is almost occupied.

FIG. 8 is a perspective view of a pair of core pieces showing their end faces facing each other before terminals are connected.

FIG. 9 is a perspective view a pair of core pieces showing their end faces facing each other after terminals are connected.

FIG. 10 illustrates the steps (a) to (c) of fusing processes while sandwiching the coated wire between the terminals.

FIG. 11 is a perspective view showing the process of attaching the core piece to the casing.

FIG. 12 is a perspective view of the choke coil product wherein the choke coil molded with resin is inserted into the casing.

FIG. 13 is a comparative example of the core piece, wherein (a) is a cross-sectional view of the core piece wound with Litz wire and (b) shows the state of the core piece wound with Litz wire until the central space is almost occupied.

FIG. 14 is an enlarged view of the enclosure B shown in FIG. 13.

FIG. 15 illustrates a comparison of the occupancy rates of the core pieces, wherein (a) shows the inventive core piece and (b) shows the core piece wound with a Litz wire.

### MODE FOR CARRYING OUT THE INVENTION

The choke coil 10 according to one embodiment of the present invention will be described below with reference to the drawings.

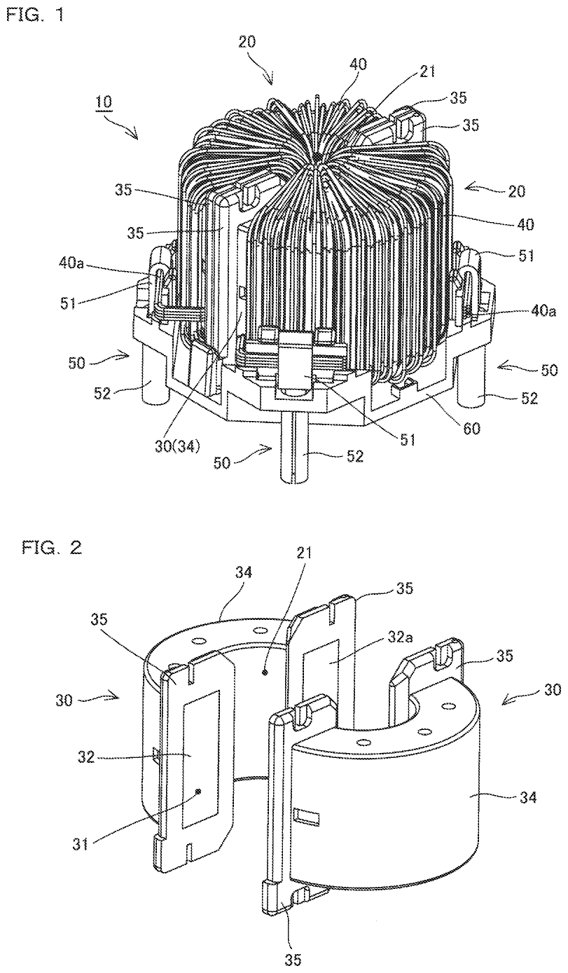

FIG. 1 is an external perspective view of a choke coil 10 of one embodiment of the invention. As explained in the manufacturing process below, the choke coil 10 is formed by placing a pair of arc-shaped core pieces 20, 20 wound with coated wires 40 on a base 60 of plastic material. Each of the coated wires 40 has end edges 40a, 40a that are electrically connected to the terminals 50. Three terminals 50 are shown in the illustration.

The choke coil 10 having the above-described structure may be manufactured in the following manner.

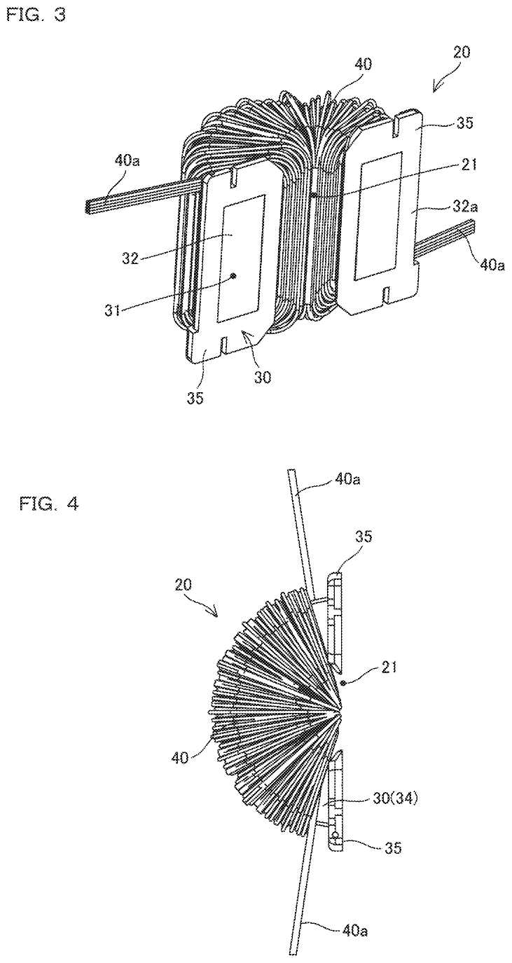

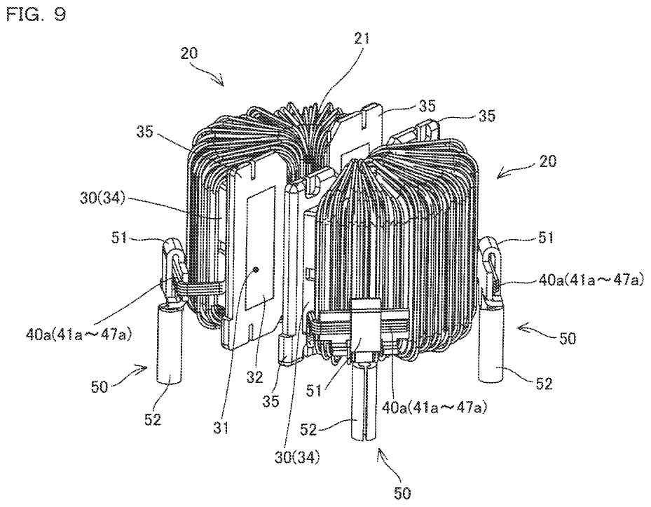

The core piece 20 is prepared by winding the coated wire 40 around a covered core 30 (shown in FIG. 2), as shown in FIGS. 3 and 4, and then mounting the terminals 50, as shown in FIG. 9.

The covered core 30 comprises an arc-shaped core segment 31 (a cross-sectional view of the core segment is shown in FIG. 5) made of a magnetic material and a bobbin 34 made of an electrically insulating material, wherein the core segment 31 is covered on an outer periphery thereof with the bobbin 34. More specifically, the core segment 31 is covered with the bobbin 34 except the area of end faces 32 and 32a. It is noted that a molded insulating coating formed by surface treatment can be used in replacement of the bobbin 34.

The covered core 30 can be in an arc-shaped form and has a semi-circular space on the inner side. The semi-circular space is to provide a central hole 21 of a toroidal core. A pair of the covered cores 30, 30 are placed with their end faces 32, 32a facing each other to form an annulus in a plan view. The covered cores 30, 30 (core segments 31, 31) may have a shape configured to be formed in an elliptical, racetrack, rectangular, or other shape in a plan view, when combined. The core segment 31 illustrated in the figures is an approximately rectangular cross-sectional shape, but is not limited to it. The core segment 31 may be dust cores or ferrite cores made by sintering green compact of magnetic powders. The core segment 31 may be cut from a toroidal-shaped body or may utilize a molded body preformed into a circular arc shape. However, the dust core is affected by a high molding pressure, so the core segment is preferable to cut the toroidal-shaped body rather than using the body molded into the arc-shaped form. For the ferrite core, when fired into an arc-shaped form, their end faces 32, 32a to be served as abutting surfaces are subjected to deformation by the firing, so the core segment is desirable to obtain from the toroidal-shaped body. In addition, the core segment produced by cutting the toroidal-shaped body has better magnetic properties.

Bobbin 34 can be molded around the circumference of the core segment 31 by subjecting an insulating resin material to an insert molding or other means and may provide flanges 35, 35 extending from the portion adjacent to the end faces 32, 32a of the core segment 31.

The covered core 30 can be prepared, for example, by subjecting a toroidal-shaped core to the insert molding to provide a coating of bobbin 34 and then cutting the core along the flanges 35, 35. Cutting can be performed by water-cooled grinding wheel rotary cutting, wire sawing, fiber laser cutting using a laser, water laser cutting and the like.

The coated wire 40 is wound on the covered core 30 from one end face 32 to the other end face 32a to form a core piece 20 as shown in FIGS. 3 and 4. The coated wire 40 can be a configuration of a solid wire and uses an insulation coated copper wire such as a magnet wire, or a fusible wire for providing additional fusion function on the insulation coated surface.

Specifically, a plurality of the coated wire 40 of a solid wire are wound in parallel on the covered core 30, as shown in the illustration. For example, as shown in FIG. 5 (a), a first coated wire 41 is wound around the covered core 30, as a first step. The first coated wire 41 is wound until the inner circumference (on the side of the central space 21) of the covered core 30 is almost occupied, whereby a first layer 41b of the coated wire 40 is formed. The end edges of the coated wire 41 preferably extend outside of the flanges 35, as shown by the sign 40a in FIGS. 3 and 4 and by the sign 41a in FIG. 5 (a).

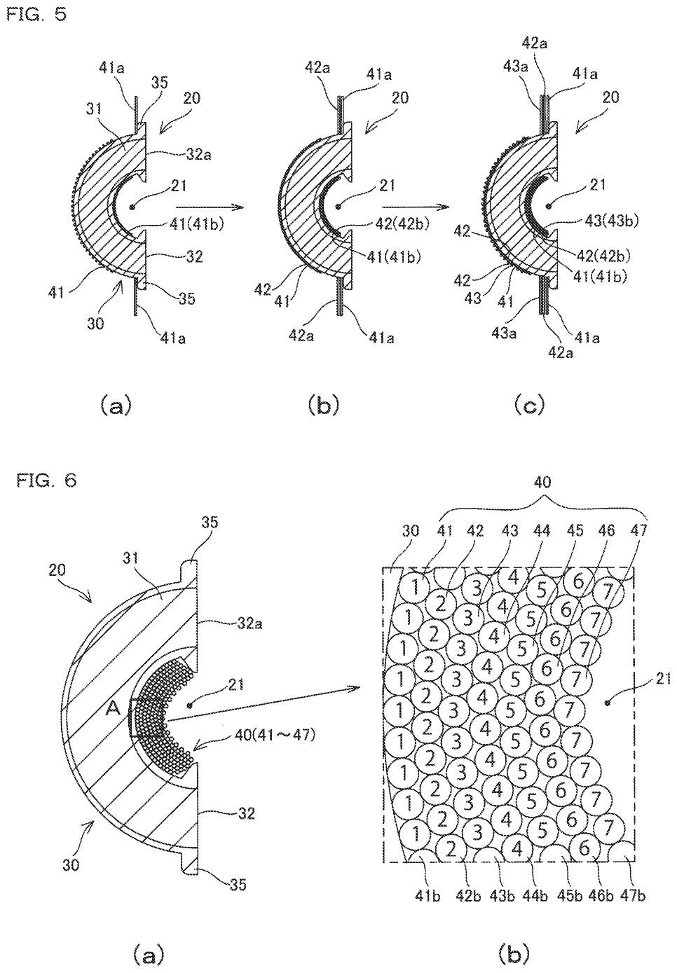

A second coated wire 42 is then wound as shown in FIG. 5 (b). The second coated wire 42 forms a second layer 42 on the first layer 41b. On the side of the central space 21 (See FIG. 6 (b): the coated wire is illustrated only on the side of the central space 21), the second coated wire 42 is preferably fitted into a valley portion formed between adjacent coated wires 41 of the first layer 41b and wound in a multi-stacked state like a trefoil shape. This reduces a gap “s” between the coated wires 41, 42 and achieves an increase in the occupancy ratio. On the outer periphery side of the covered core 30, a clearance is created between the adjacent first coated wires 41, and the second coated wire 42 can be fitted in such a clearance and wound around the covered core 30. The end edges of the second coated wire 42 extend outside of the flanges 35, as shown by the sign 40a in FIGS. 3 and 4 and by the sign 42b in FIG. 5 (b), as with the first coated wire 41.

Then, the third coated wire 43 is wound, as shown in FIG. 5 (c). As with the second layer 42b (See FIG. 6 (b)), on the side of the central space 21, the third coated wire 43 is fitted into a valley portion produced between adjacent coated wires 42 of the second layer 42b (See FIG. 6 (b)). If a clearance is created between the first coated core 41 and the second coated core 42 on the outer periphery side of the covered core 30, the third coated wire 43 is fitted in the clearance. But if there is no such a clearance, the third coated wire 43 can be fitted into a valley portion between the first coated core 41 and the second coated core 42. The end edges of the third coated wire 43 also extend outside of the flanges 35, as shown by the sign 40a in FIGS. 3 and 4 and by the sign 43b in FIG. 5 (b).

Depending on the required coil performance, the coated wire 40 can be wound onto the coated core 30 in layers. FIG. 6 shows an embodiment of the core piece 20 wherein the coated wire 40 is wound around the covered core 30 to form seven (7) layers when the number of turns of the coated wire 40 per one layer is 35 (the coated wires are shown only on the side of the central space 21). FIG. 6 (b) shows an enlarged view of portion A indicated in FIG. 6 (a), in which the seven layered coated wires 40 are referred to as 41b-47b. Parallel windings of the seven layers provide 7×35=245 turns, whereby a coil suitable for high frequencies can be produced.

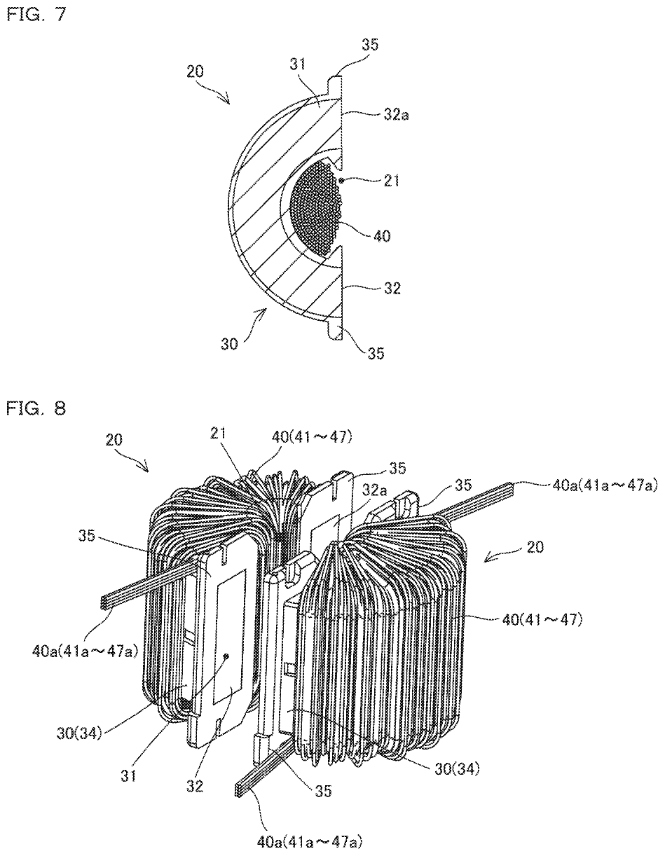

FIG. 7 shows the state in which the coated wire is wound until the central space 21 of the covered core 30 is almost occupied, that is, until a position in alignment with the line connecting the end faces 32, 32a. In the illustrated embodiment, when 35 turns of winding the coated wire 40 are additionally made for three times while allowing overlapping of layers, the wound-coated core is in the state where the central region of the coated wire 40 slightly bulges. If the 35 turns of the coated wire 40 is counted as one layer, as in the above embodiment, this embodiment corresponds to ten (10) layers of parallel winding, and provides 10×35=350 turns, whereby a coil suitable for further higher frequencies can be produced.

For the windings of the coated wire 40, a plural coated wires are wound in the same direction from one end face 32 of the covered core 30 to the other end face 32a, i.e., without changing the direction of winding. Alternatively, a single coated wire may be wound by going from one end face 32 toward the other end face 32a (outward way) and then changing the direction from the other end face 32a to the one end face 32 (return way). In this case, the direction of the coated wire 40 changes by 180 degrees from the outward way to the return way. That is, the coated wire 40 is wound around the covered core 30 in the same winding direction when viewed from the side of one end face 32. Whichever of these methods is used, the winding can be performed automatically using automatic winding equipment with nozzles, such as a flyer-type winding machine. Therefore, the coated wire 40 can be wound tightly, and the number of turns (number of windings) can be controlled precisely. In addition, the automatic winding machine allows for high manufacturing efficiency, high quality, and steady supply of the coil.

While winding the coated wire 40, the end edges 41a of the already wound coated wire 40 are preferably clamped by a jig in sequence. This prevents variations and unwinding of the end edges 41a. Instead of the jig, it may be sequentially held in the bend 51 (See FIG. 9) of the terminal 50.

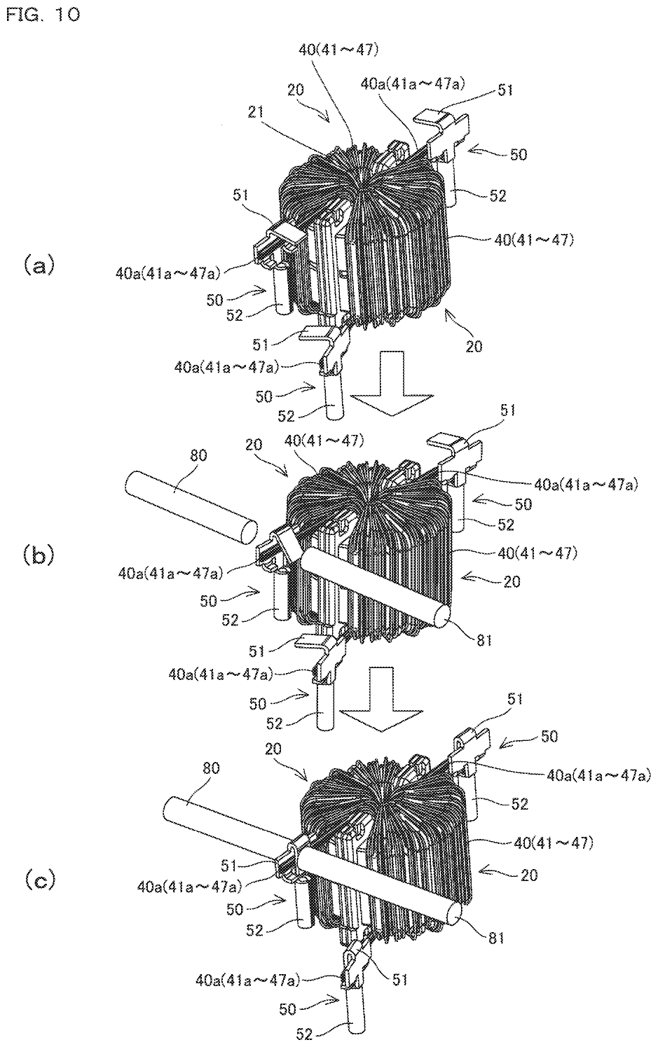

Then, the coated wire 40 wound around the core piece 20 can be fitted with a terminal 50, as shown in FIG. 9, and the end edge 40a (41a-47a) of the coated wire 40 is electrically connected to the terminal 50. For example, the terminal 50 is formed on the lower side thereof with an external contact 52 and on the upper side thereof with a bend 51 adapted to clamp the coated wire 40. In this case, first, the end edge 40a (41a-47a) of the coated wire 40 (41-47) is clamped in the bend 51, as shown in FIG. 10 (a), and then is subjected to a fusion working process that is a thermal crimping welding process utilizing electrical resistance. During the fusing process, the bend 51 is folded by electrode terminals 80, 81 for fusing, and the molded insulating coating on the end edges 40a (41a-47a) of the coated wire 40 (41-47) is removed, whereby the end edges 40a and the terminals 50 are electrically and structurally connected each other, as shown in FIG. 10 (c). The joining of the coated wire 40 and terminal 50 can be performed not only by the fusion working process but also by various welding methods such as resistance welding, TIG welding, and plasma welding, or by soldering after mechanical stripping or film stripping using chemicals such as strong acids or strong alkaline agents. Any of these methods can be used to remove the molded insulating coating of the coated wire 40 and to make an electrical connection of the coated wire 40 to the terminal 50.

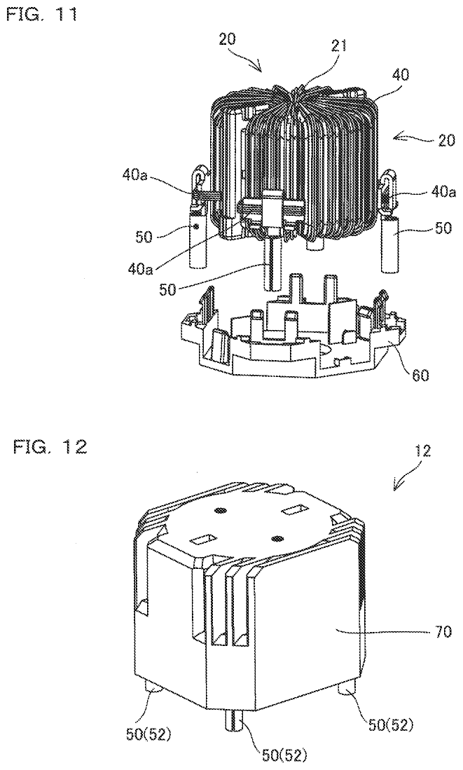

Thus, the core piece 20 wherein the terminals 50 and the coated wire 40 are electrically connected is prepared as a pair of core pieces. One core segment 31 and the other core segment 31 are butted together in such a way that the end faces 32, 32a of the one core segment 31 and the end faces 32, 32a of the other core segment 31 face to each other, and the flanges 35, 35 face to each other. The pair of core pieces are placed on the base 60, as shown in FIG. 11, to obtain the choke coil 10 shown in FIG. 1. To achieve the desired DC superposition characteristics (inductance versus current), the end faces of the core segments 31, 31 may be in contact with each other or may have a gap to insert electrically insulating spacers between them.

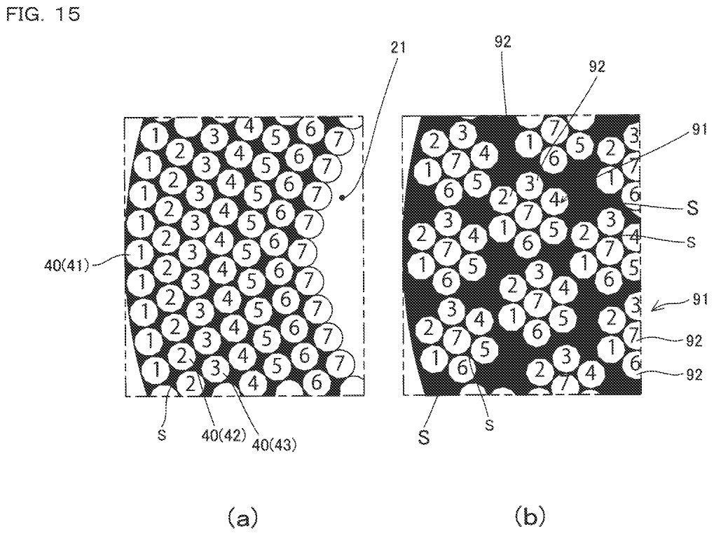

For the resulting choke coil 10, the coated wire 40 can be densely wound around each core piece 20, so that the occupancy ratio of the coated wire 40 can be increased to 60% to 70% or more, as described below with reference to FIG. 15. This enhanced occupancy ratio of the choke coil 10 provides an increased inductance. The choke coil 10 itself can be made smaller, lighter, more efficient, and smaller DC resistance. In particular, the coated wire 40 can be made of general-purpose solid wires of various diameters or solid wires such as magnet wires, so there is no need to use expensive Litz wire that requires specialized design and take time to obtain. Therefore, it can achieve cost reductions and shorter lead time for manufacturing than the choke coil using Litz wire. In addition, the present choke coil also has a higher occupancy ratio because the coated wire is not twisted, and the number of wires can be set arbitrarily.

Since the core piece 20 has flange portions 35, 35, the core pieces 20, 20 are electrically insulated between the coated wires 40, 40, thus preventing any electrical contact or short circuit between them. It is also preferable to provide electrical insulation between the coated wires 40, 40 by inserting an electrically insulating resin plate or the like on the side of the central space 21 of the core pieces 20, 20.

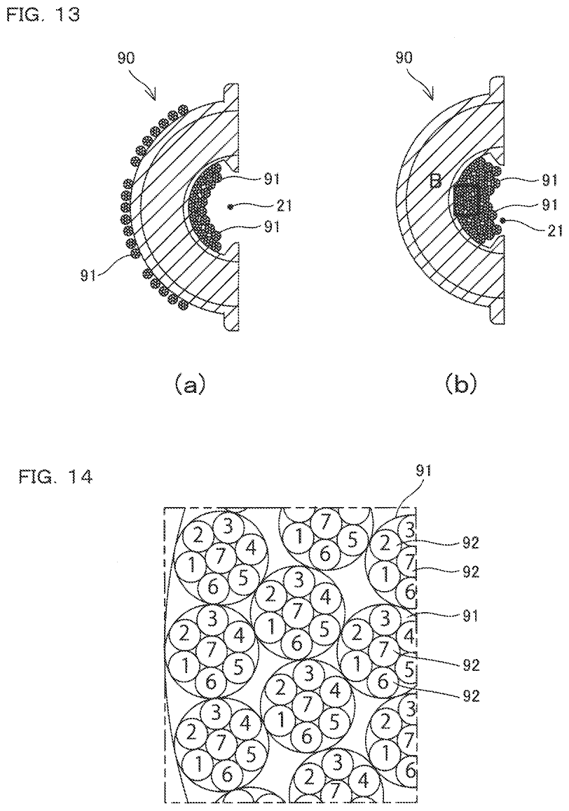

As the core pieces 20, 20 of the present choke coil 10 are placed on the base 60 and are not fixed to each other, a gap may arise on the butted portion, causing it to open up. Therefore, the core pieces 20, 20 are usually fixed to each other using adhesives, but as shown in FIG. 12, the choke coil 10 of the present invention can be resin-coated by the insert molding or resin molding (potting) and then inserted into a casing 70 to make a choke coil product 11. The choke coil 10 may be housed in a casing 70 to improve heat dissipation characteristics and to achieve heat equalization. The casing 70 can be made of a resin material having high thermal conductivity or may have a structure with a heat sink. Furthermore, as shown in FIG. 12, the top surface of the casing 70 can be flattened to further enhance heat dissipation by utilizing a heat sink or chassis to increase the area in contact for easier heat dissipation. The casing 70 having a flat top surface provides the insulation and heat dissipation functions of the casing 70, thus improving heat dissipation including the set implementation, without the use of insulating silicone sheets having high thermal conductivity.

The choke coil product 11 in the above configuration can be installed on a board or similar device and used as a choke coil for noise prevention circuits, waveform shaping circuits, resonance circuits, and various switching circuits in AC equipment such as power circuits and inverters. Choke coil products 11 of the present invention are suitable as choke coils used as a countermeasure for high-frequency distortion current in the circuit having Power Factor Correction in switching power supplies and the like where choke coil products for high frequencies above 10 kHz are used. In addition, the present choke coils can be used for impedance matching and also as a high-frequency smoothing choke coil. However, the present choke coil is not suitable for filter applications that obtain attenuation at high frequencies, such as common-mode choke coils and normal-mode choke coils, even for high-frequency applications.

The above description is intended to explain the invention and should not be construed as limiting or restricting the scope of the invention as recited in the claims. The present invention is not limited to the above-mentioned embodiments, and various modifications can be made within the technical scope of the claims.

### EXAMPLES

A core piece 20 with parallel windings of the coated wire 40 of the present invention and a core piece 90 with windings of Litz wire 91 were prepared to compare their occupancy rates. The inventive example is the core piece shown in FIG. 6, wherein the coated wire is wound in parallel with 35 turns per layer and 245 turns in 7 layers. The comparative example uses a Litz wire 91 of 7 stranded wires, which are wound around the coated core in parallel by repeating 35 turns 7 times with 245 turns in total, in the same manner as the inventive example. The wound-coated wires are shown in FIG. 13 (b). FIG. 6 (b) shows a cross-sectional view of the winded portion of the coated wire 40 in the inventive example, and FIG. 14 shows a cross-sectional view of enclosure B in FIG. 13 (b) for the core piece 90 in the comparative example. Furthermore, the clearance areas that do not contribute to the occupancy ratio in FIGS. 6 (b) and 14 are indicated as black colored in FIGS. 15 (a) and 15 (b), respectively.

Referring to FIG. 6 (a) and FIG. 13 (b), the inventive example can be wound thinner than the comparative example without expanding toward the side of the central space 21, despite the same number of turns. The inventive example shown in FIG. 6 (b) indicates that each of the coated wire 40 is tightly wound in layers without clearance, while the comparative example shown in FIG. 14 has gaps between Litz wires 91 and also between copper wires 92 that constitute the Litz wire 91. As shown in black in FIGS. 15 (a) and 15 (b) in more detail, the inventive example only has a gap “s” between the coated wires 40 (41-47), while the comparative example has a gap “S” between the Litz wires 91 in addition to a gap “s” between the copper wires 92. This resulted a difference in an occupancy rate of about 65% for the inventive example, while the comparative example had an occupancy rate of about 45% and was about 20% lower than that of the inventive example. A 20% increase in the occupancy ratio for the same core size can increase the inductance value by as much as the square of 1.2 (1.44) times. In other words, the inventive example can reduce the core size by about 20% compared to the comparative example to achieve equivalent performance.

The inventive example can employ a solid coated wire 40, which allows more flexibility in terms of wire diameter, material, etc., compared to the Litz wire 91. The inventive example achieves about a 17% reduction of the copper loss (DC resistance) and the heat generation by increasing the occupancy ratio to thicken the coated wire by only a 10% (e.g., from 0.5 mm to 0.55 mm in diameter).

### EXPLANATION OF REFERENCE NUMBERS

10 Choke coil

11 Choke coil product

20 Core piece

21 Central space

30 Coated core

31 Core segment

32 End face

32a End face

34 Bobbin

35 Flange portion

40 (41-47) Coated wire

40a (41a-47a) End edge

50 Terminal

1-7. (canceled)

8. A choke coil comprising a pair of core pieces,
wherein each of the core pieces comprises
an arc-shaped core segment having end faces,
a molded insulating coating to cover the core segment and provide the core segment with an electrical insulation, the molded insulating coating having flanges extending outward from each of the end faces of the core segment,
a coated wire wound around the molded insulating coating, and
terminals disposed near the flanges of the molded insulating coating and electrically connected to the coated wire,
wherein the choke coil is a toroidal shape formed by placing the end faces of the arc-shaped core segment of one of the core pieces to face the end faces of the arc-shaped core segment of the other core piece, and
the coated wire is wound around the circumference of the molded insulating coating, in parallel without being twisted to each other.

9. The choke coil according to claim 8, wherein the coated wire is wound in layers along a peripheral surface of the molded insulating coating, wherein a first layer of one coated wire is present on the inner most circumferential side of the molded insulating coating, and a second layer of one coated layer is stacked on the outer circumference of the first layer in sequence.

10. The choke coil according to claim 8 wherein the coated wire is wound while changing the direction of winding at the terminals.

11. The choke coil according to claim 9 wherein the coated wire is wound while changing the direction of winding at the terminals.

12. The choke coil according to claim 8 wherein the coated wire comprises a plural coated wires that are wound without changing the direction of winding.

13. The choke coil according to claim 9 wherein the coated wire comprises a plural coated wires that are wound without changing the direction of winding.

14. The choke coil according to claim 8, wherein on the inner circumferential side of the molded insulating coating, the central region of the wound-coated wire bulges.

15. The choke coil according to claim 9, wherein on the inner circumferential side of the molded insulating coating, the central region of the wound-coated wire bulges.

16. The choke coil according to claim 10, wherein on the inner circumferential side of the molded insulating coating, the central region of the wound-coated wire bulges.

17. The choke coil according to claim 11, wherein on the inner circumferential side of the molded insulating coating, the central region of the wound-coated wire bulges.

18. The choke coil according to claim 8 wherein the terminals are electrically connected to the coated wire via resistance welding, welding method, or soldering.

19. The choke coil according to claim 9 wherein the terminals are electrically connected to the coated wire via resistance welding, welding method, or soldering.

20. The choke coil according to claim 10 wherein the terminals are electrically connected to the coated wire via resistance welding, welding method, or soldering.

21. The choke coil according to claim 11 wherein the terminals are electrically connected to the coated wire via resistance welding, welding method, or soldering.

22. A choke coil product wherein the choke coil according to claim 8 is coated on the outer circumference thereof with resin.

23. A choke coil product wherein the choke coil according to claim 9 is coated on the outer circumference thereof with resin.

24. A choke coil product wherein the choke coil according to claim 10 is coated on the outer circumference thereof with resin.

25. A choke coil product wherein the choke coil according to claim 11 is coated on the outer circumference thereof with resin.
